(19) United States
(12) Patent Application Publication
(10) Pub. No.: US 2015/0098049 A1
(43) Pub. Date: Apr. 9, 2015

(54) LIQUID CRYSTAL DISPLAY AND MANUFACTURING METHOD THEREOF

(71) Applicant: Samsung Display Co., Ltd., Yongin-city (KR)

(72) Inventor: Chang-Hun LEE, Hwaseong-si (KR)

(21) Appl. No.: 14/451,487

(22) Filed: Aug. 5, 2014

(30) Foreign Application Priority Data
Oct. 4, 2013 (KR) 10-2013-0118784

(51) Int. Cl. G02F 1/1337; G02F 1/1333

(52) U.S. Cl. CPC G02F 1/133707; G02F 1/133345; G02F 1/1333
USPC 349/110; 349/138; 349/123; 445/24

(57) ABSTRACT

A liquid crystal display includes a first insulating substrate; a gate line and a data line disposed on the first insulating substrate and insulated from each other to cross each other; a thin film transistor connected to the gate line and the data line; an organic layer disposed on the thin film transistor; a pixel electrode disposed on the organic layer; a passivation layer disposed on the pixel electrode; and a common electrode disposed on the passivation layer, in which shapes of the passivation layer and the common electrode correspond to each other in a pixel area. The device reduces a DC bias generated when charges are collected on either the pixel electrode or the common electrode in a display device that displays an image by generating an electric field between two field generating electrodes of the pixel electrode and the common electrode.

### CROSS REFERENCE TO RELATED APPLICATION

This application claims priority from and the benefit of Korean Patent Application No. 10-2013-0118784, filed on Oct. 4, 2013, which is hereby incorporated by reference for all purposes as if fully set forth herein.

### BACKGROUND

1. Field

Exemplary embodiments of the present invention relate to a liquid crystal display and a manufacturing method thereof.

2. Discussion of the Background

A display device, such as a liquid crystal display (LCD) or an organic light emitting diode (OLED) display, generally includes a display panel and a driving apparatus driving the display panel.

The display panel includes a plurality of signal lines connected to a plurality of pixels and arranged in a substantially matrix form. The signal lines typically include a plurality of gate lines transferring gate signals and a plurality of data lines transferring data voltages.

Each pixel may include at least one switching element connected to the corresponding gate and data lines, at least one pixel electrode connected thereto, and an opposed electrode facing the pixel electrode and receiving a common voltage. The switching element may include at least one thin film transistor, and may be turned on or off according to the gate signal. The gate signal is transferred by the gate line, selectively transferring the data voltage transferred by the data line to the pixel electrode. Each pixel displays an image at a corresponding luminance according to a difference between the data voltage applied to the pixel electrode and the common voltage. The difference between the data voltage applied to the pixel electrode and the common voltage is called a pixel charge voltage or a pixel voltage.

For example, the liquid crystal display includes a display panel with the pixel electrode and the opposed electrode, and a liquid crystal layer having dielectric anisotropy. The pixel electrodes are arranged in a matrix form and connected to the switching elements such as a thin film transistor (TFT) to sequentially receive data voltages for each row. The opposed electrodes are formed throughout the display panel to receive common voltages. An image may be acquired by applying the voltages to the pixel electrode and the opposed electrode to generate an electric field in the liquid crystal layer and controlling an intensity of the electric field to control transmittance of light passing through the liquid crystal layer. Luminance of the image displayed by the pixel of the display device may vary according to the difference between the voltage of the pixel electrode and the common voltage of the opposed electrode.

The driving apparatus typically includes a gate driver generating gate signals and a data driver generating data voltages, a gray reference voltage generator supplying a gray reference voltage to the data driver. The driving apparatus also typically includes a signal controller that controls the gate driver, the data driver, and the gray reference voltage generator. The drivers may be directly installed on the display panel in at least one integrated circuit (IC) chip form, installed on a film such as a flexible printed circuit film to be attached to the display panel in a tape carrier package (TCP) form, installed on a separate printed circuit board, or integrated on the display panel together with the signal line, the thin film transistor, and other elements.

The driving apparatus may convert a digital input image signal including gray information input from an external system into an analog image signal by using a gray voltage. The gray voltage supplies the converted analog image signal to each pixel, thereby displaying the image. The gray voltage is a voltage selected as the data voltage in response to the gray of the input image signal and varies according to gamma data which is information for a slope of a gray level and luminance of the image.

The gray voltage includes a gray voltage having a positive polarity and a gray voltage having a negative polarity based on the common voltage. The gray voltage may be generated from positive and negative gray reference voltages which have a smaller number than the gray voltages.

The gray reference voltage generator of the driving apparatus receives and divides a power voltage or a reference voltage to generate positive and negative gray reference voltages.

The data driver receives and divides the positive and negative gray reference voltages from the gray reference voltage generator to generate gray voltages for all the grays. The data driver selects a gray voltage corresponding to the input image signal among the plurality of gray voltages to apply the selected gray voltage as the data voltage to the data line.

The data voltage is applied to the pixel electrode through the switching element. The polarity for the common voltage of the data voltage may be inverted according to a number of frames. However, the pixel voltage may drop by a kickback voltage by a parasitic capacitance between terminals of the switching element when the switching element of the pixel is turned off. In addition, the kickback voltage may vary according to a gray or various other factors such as a leakage current of the thin film transistor due to a process deviation between display panels or regions, signal delay of a wire, and/or a deviation of a capacitance change of a liquid crystal capacitor according to a data voltage or a temperature change in the case of the liquid crystal display. In this case, in the case where the polarities for the common voltage of the data voltage applied to the pixel are positive and negative, a deviation between actual voltages charged in the pixel occurs. Accordingly, when the image is displayed, charges may be collected toward either the pixel electrode or the opposed electrode, and a direct current bias (referred to as a residual DC) is generated and thus an afterimage may be generated.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a liquid crystal display and a manufacturing method thereof having advantages of solving a DC bias generated when charges are collected on either the pixel electrode or the common electrode to prevent a DC bias afterimage.

An exemplary embodiment of the present invention provides a liquid crystal display, including: a first insulating substrate; a gate line and a data line disposed on the first insulating substrate and insulated from each other to cross each other; a thin film transistor connected to the gate line and the data line; an organic layer disposed on the thin film transistor; a pixel electrode disposed on the organic layer; a passivation layer disposed on the pixel electrode; and a common electrode disposed on the passivation layer, in which shapes of the passivation layer and the common electrode correspond to each other in a pixel area, and the pixel electrode is exposed through the opening.

Another exemplary embodiment of the present invention provides a manufacturing method of a liquid crystal display, including: forming a gate line on a first insulating substrate; forming a gate insulating layer on the gate line; forming a data line on the gate insulating layer; forming an organic layer including a contact hole on the data line; forming a pixel electrode disposed on the organic layer; forming a passivation layer covering the pixel electrode; and forming a common electrode on the passivation layer, in which shapes of the passivation layer and the common electrode correspond to each other in a pixel area, and the pixel electrode is formed to be exposed through the openings.

According to the exemplary embodiment of the present invention, in the display device displaying an image by generating an electric field between two field generating electrodes of the pixel electrode and the common electrode, it is possible to reduce generation of a DC bias afterimage due to a DC bias generated when charges are collected on either the pixel electrode or the common electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of one pixel of a display device according to an exemplary embodiment of the present invention.

FIG. 2 is a cross-sectional view taken along line II-II of FIG. 1.

FIG. 3 is a cross-sectional view taken along line III-III of FIG. 1.

FIG. 4 is a cross-sectional view taken along line IV-IV of FIG. 1.

FIGS. 5, 8, 11, 14, 17, and 20 are cross-sectional views taken along line II-II of FIG. 1 illustrating a manufacturing process of a lower panel of a display device according to an exemplary embodiment of the present invention.

FIGS. 6, 9, 12, 15, 18, and 21 are cross-sectional views taken along line III-III of FIG. 1 illustrating a manufacturing process of a lower panel of a display device according to an exemplary embodiment of the present invention.

FIGS. 7, 10, 13, 16, 19, and 22 are cross-sectional views taken along line IV-IV of FIG. 1 illustrating a manufacturing process of a lower panel of a display device according to an exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” or “connected to” another element, it can be directly on or connected to the other element or intervening elements may also be present. In contrast, when an element is referred to as being “directly on” or “directly connected to” another element, there are no intervening elements present.

A liquid crystal display according to an exemplary embodiment of the present invention will be described in detail with reference to the accompanying drawings.

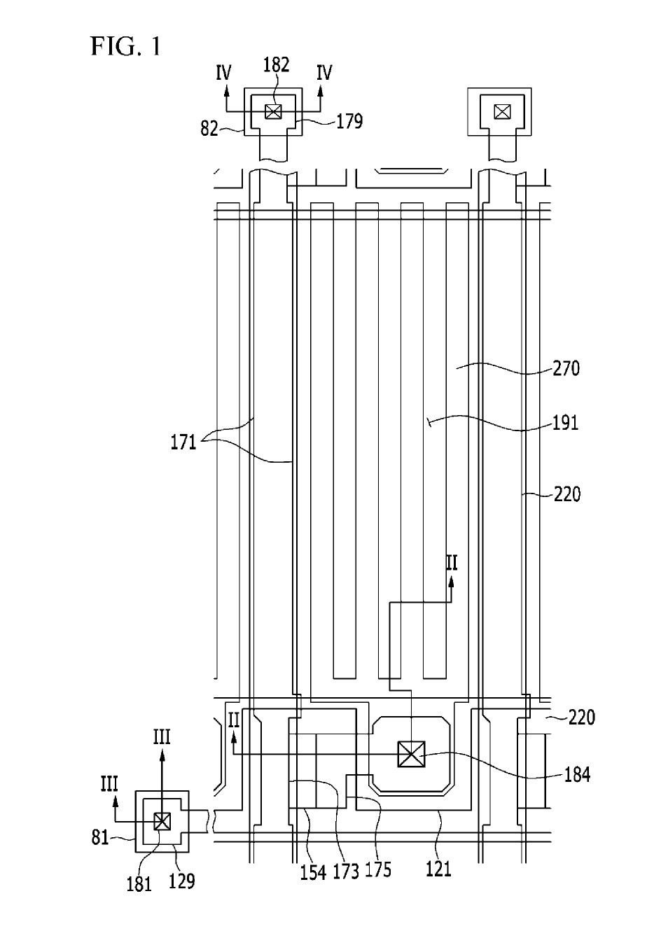

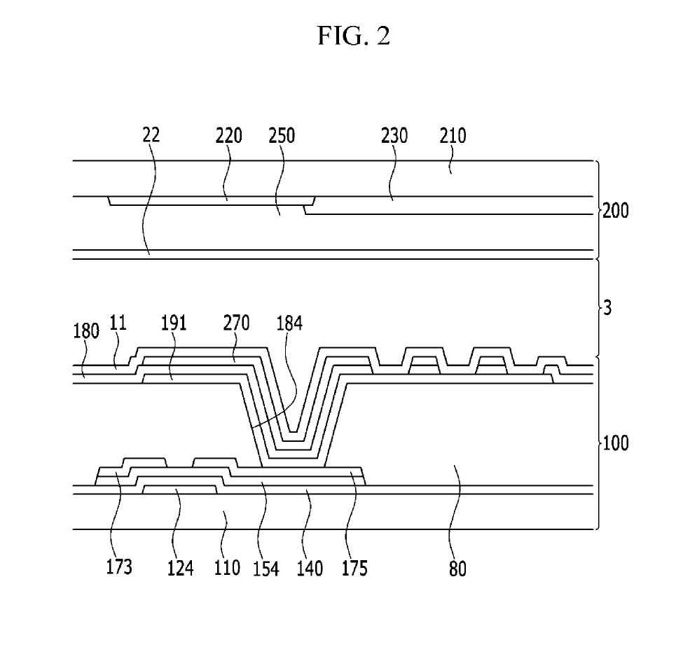

Referring to FIGS. 1 and 2, a liquid crystal display according to an exemplary embodiment of the present invention includes a lower panel 100 and an upper panel 200 facing each other, and a liquid crystal layer 3 interposed therebetween. One pixel area will be described below as an example, but the liquid crystal display according to the exemplary embodiment of the present invention may have resolution of about 150 PPI or more. That is, 150 or more pixels may be included in a region of about 1 inch in width and length of the liquid crystal display. Here, the horizontal width of the pixel is a distance between vertical centers of two adjacent data lines 171, and the vertical length of the pixel is a distance between horizontal centers of two adjacent gate lines 121.

The lower panel 100 will now be described.

A gate conductor including a gate line 121 is disposed on a first insulating substrate 110 made of, for example, transparent glass, plastic, or other suitable materials.

The gate line 121 includes a gate electrode 124 and a wide gate pad 129 for connection with another layer or an external driving circuit. The gate line 121 may be made of at least one of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), and titanium (Ti). The gate line 121 may have a multilayered structure including at least two conductive layers having different physical properties.

A gate insulating layer 140, made of, for example, silicon nitride (SiNx), silicon oxide (SiOx), or another suitable material, may be formed on the gate conductor 121, 124, and 129, and may be omitted according to an exemplary embodiment of the present invention.

The gate insulating layer 140 may have a multilayered structure including at least two insulating layers having different physical properties.

A semiconductor 154 made of, for example, amorphous silicon, polysilicon, or the like is formed on the gate insulating layer 140. The semiconductor 154 may include an oxide semiconductor.

Ohmic contacts (not illustrated) may be disposed on the semiconductor 154. The ohmic contacts (not illustrated) may be made of a material such as n+hydrogenated amorphous silicon in which an n-type impurity such as phosphorus is doped at a high concentration or silicide. The ohmic contacts (not illustrated) may be disposed on the semiconductor 154 to make a pair. In the case where the semiconductor 154 is an oxide semiconductor, the ohmic contacts may be omitted.

A data conductor including a data line 171, a source electrode 173 and a drain electrode 175, is disposed on the ohmic contacts (not illustrated) and the gate insulating layer 140.

The data line 171 includes a data pad 179 for connection with another layer or an external driving circuit. The data line 171 transfers a data signal and extends in a substantially vertical direction to cross the gate line 121.

The source electrode 173 is a part of the data line 171, and disposed on the same line as the data line 171. Alternatively, the source electrode 173 may protrude from the data line 171. The drain electrode 175 is formed to extend in parallel with the source electrode 173. Accordingly, the drain electrode 175 is parallel with a part of the data line 171.

The drain electrode 175 includes a rod-shaped end portion which faces the source electrode 173; the other end portion has a large area.

A first semiconductor 159 and a second contact assistant 82 are disposed below the data pad 179. The first semiconductor 159 and the second contact assistant 82 may be omitted.

The gate electrode 124, the source electrode 173, and the drain electrode 175 form one thin film transistor (TFT) together with the semiconductor 154, and a channel of the thin film transistor is formed in the semiconductor 154 between the source electrode 173 and the drain electrode 175.

A thin film transistor array panel according to an exemplary embodiment of the present invention includes the source electrode 173 disposed on the same line with the data line 171 and the drain electrode 175 extending in parallel with the data line 171. As a result, even though an area occupied by the data conductor is not increased, a width of the thin film transistor may be increased, thereby increasing an aperture ratio of the liquid crystal display.

In the case of a thin film transistor array panel according to another exemplary embodiment of the present invention, the source electrode 173 and the drain electrode 175 may have different shapes.

The data line 171 and the drain electrode 175 may include a refractory metal such as molybdenum, chromium, tantalum, and titanium or an alloy thereof, and may have a multilayered structure including a refractory metal layer (not illustrated) and a low resistive conductive layer (not illustrated). An example of the multilayered structure may include a double layer including a chromium or molybdenum (alloy) lower layer and an aluminum (alloy) upper layer, and a triple layer including a molybdenum (alloy) lower layer, an aluminum (alloy) intermediate layer, and a molybdenum (alloy) upper layer. However, the data line 171 and the drain electrode 175 may be made of various metals or conductors other than the metals listed for exemplary purposes.

An organic layer 80 is disposed on the data conductor 171, 173, 175, and 179, the gate insulating layer 140, and an exposed portion of the semiconductor 154. The organic layer 80 may be made of an organic insulating material, an inorganic insulating material, or another insulating material.

Further, the organic layer 80 includes a plurality of contact holes, and the plurality of contact holes may be disposed at a position exposing a part of the drain electrode 175, or exposing the gate pad 129 and the data pad 179. That is, the organic layer 80 is disposed in a display area where the plurality of pixels are disposed, but may not be disposed in a peripheral area where the gate pad 129 or the data pad 179 is formed.

A first contact hole 181 is disposed in a region corresponding to the gate pad 129 where the organic layer 80 is removed. A second contact hole 182 is disposed in a region corresponding to the data pad 179 where the organic layer 80 is not disposed. A third contact hole 184 is disposed in a region corresponding to the drain electrode 175 where the organic layer 80 is not disposed.

In the case of a thin film transistor array panel according to another exemplary embodiment of the present invention, the organic layer 80 may be omitted.

Next, a pixel electrode 191 is disposed on the organic layer 80. The pixel electrode 191 may be formed of a transparent conductive layer including indium tin oxide (ITO) or indium zinc oxide (IZO), but is not limited thereto and may be formed of any transparent conductive oxide (TCO). Further, the pixel electrode 191 according to the exemplary embodiment of the present invention has a planar shape.

The pixel electrode 191 is physically and electrically connected to the drain electrode 175 through the third contact hole 184 of the organic layer 80 to receive a voltage from the drain electrode 175.

Next, a passivation layer 180 is disposed on the pixel electrode 191. The passivation layer 180 may be made of an organic insulating material, an inorganic insulating material, or another suitable material.

The passivation layer 180 is not disposed at a position corresponding to the first contact hole 181 and the second contact hole 182. Further, the passivation layer 180 is not disposed in the pixel area and may include a plurality of openings. Except for an alignment layer, the common electrode or the pixel electrode is exposed at the top.

Further, the passivation layer 180 for preventing a short of the pixel electrode 191 and the common electrode 270 may be thinly formed in a range such that the short is not generated. In an exemplary embodiment of the present invention, a thickness of the passivation layer 180 may be from about 500 Å to about 3,000 Å. When the thickness of the passivation layer 180 is below about 500 Å, a short is generated between the pixel electrode 191 and the common electrode 270. However, when the thickness of the passivation layer 180 is above about 3000 Å, afterimages are often generated.

When the charges are collected on the lower panel 100 by a DC bias, the effect due to one charge varies according to a thickness of the passivation layer 180.

That is, when the thickness of the passivation layer is large, the effect due to one charge is increased. As a result, an afterimage is generated rapidly and an afterimage release is generated rapidly.

However, as described above, when the passivation layer 180 has a small thickness, a DC bias reduction effect generated by one charge is reduced, and as a result, the afterimage generated by the DC bias may be slowly generated or reduced.

Next, the common electrode 270 is disposed in a region where the passivation layer 180 and the gate pad 129, and the data pad 179 are exposed. The common electrode 270 and the passivation layer 180 correspond to each other and form a plurality of openings disposed in the pixel area. The common electrode 270 corresponds to the plurality of openings in the passivation layer 180 and may have a branch shape. In this specification, only the common electrode 270 having a branch shape substantially perpendicular to gate line 121 is illustrated and other constituent elements are described based on the common electrode 270, but the embodiments are not limited thereto and may have a branch shape in a parallel direction to the gate line 121.

The common electrode 270 having the branch shape in the vertical direction to the gate line 121 may use a positive-type liquid crystal, and the common electrode 270 having the branch shape in the horizontal direction to the gate line 121 may use a negative-type liquid crystal.

The common electrode 270 may also be made of a transparent conductive layer such as TCO including ITO or IZO.

Accordingly, the common electrode 270 and the passivation layer 180 have the same pattern in the pixel area. The common electrode 270 is disposed above, and the pixel electrode 191 having the planar shape is exposed in the opening by the common electrode 270 and the passivation layer 180. That is, in the pixel area, except for the alignment layer, the common electrode 270 or the pixel electrode 191 is disposed on the uppermost side and exposed.

A first contact assistant 81 is formed on the gate pad 129 exposed through the first contact hole 181, and a second contact assistant 82 is formed on the data pad 179 exposed through the second contact hole 182.

In this case, the common electrode 270, the first contact assistant 81, and the second contact assistant 82 may be simultaneously formed on the same layer.

The data line 171, the pixel electrode 191, and the common electrode 270 may have a curved portion in order to achieve maximum transmittance of the liquid crystal display. The curved portion may have a V-shape that meets in a middle region of the pixel area. An additional curved portion may be curved to form an angle with the curved portion, and may be further included in the middle region of the pixel area. However, the shapes of the data line 171, the pixel electrode 191, and the common electrode 270 are not limited to the aforementioned shapes, and may have any shape such as a straight shape as illustrated in the drawing.

The common electrode 270 is disposed on the organic layer 80 as illustrated in FIG. 2 and generates an electric field with the pixel electrode 191 facing the common electrode 270 to align the liquid crystal.

An alignment layer 11 is coated on the common electrode 270 and the passivation layer 180. The alignment layer may be a horizontal alignment layer and is rubbed in a direction. Further, the material forming the alignment layer 11 as described above may include any material having the resistivity value without causing polarization. Particularly, the alignment layer 11 may not include a mixed material in which polyimides and polyamic acids coexist.

When the alignment layer 11, including the mixed material, maintains the mixed state that reduces the effect due to the DC bias, the effect due to the DC bias is continuously changed. In such a state, the afterimage may be continuously generated according to the change of the DC bias. Accordingly, the alignment layer of the liquid crystal display according to the exemplary embodiment of the present invention may primarily include polyimides other than the mixed material. Resistivity of such an alignment layer may be from about 10⁻¹⁴ Ω·m to about 10⁻¹⁶ Ω·m. The ranges of the resistivity prevent from occurring afterimages.

The alignment layer 11 is rubbed in the direction as described above, and particularly, rubbed toward a light blocking member having a large width. According to the exemplary embodiment of the present invention, a light blocking member disposed in a horizontal direction is wider than a light blocking member disposed in a vertical direction. In this case, the alignment layer may be rubbed toward the light blocking member disposed in the horizontal direction.

In detail, in the display device having the branch-shaped electrode structure parallel with data line and including the positive-type liquid crystal as illustrated in FIG. 1, the rubbing direction is parallel with the branch-shaped electrode, and thus, the alignment layer is rubbed toward the gate line 121. That is, the alignment layer is rubbed toward the light blocking member having a larger width.

Although not illustrated, in a display device having the structure wherein the branch-shaped electrode is parallel with the gate line 121 and includes the negative-type liquid crystal, the rubbing direction is perpendicular to the branch-shaped electrode, and thus the alignment layer is rubbed toward the gate line 121. That is, the alignment layer is rubbed toward the light blocking member having a larger width.

As described above, regardless of a kind of the liquid crystal, in the case where the alignment layer is rubbed toward the gate line 121, a linear afterimage is vertical thereto and may be covered by the light blocking member.

Although not illustrated, in a case wherein the light blocking member disposed in the vertical direction is wider than the light blocking member disposed in the horizontal direction, the alignment layer 11 may be rubbed toward the light blocking member disposed in the vertical direction, that is, the data line 171.

Such a configuration reduces the linear afterimage generated perpendicular to the rubbing direction. As an example, in the case where the alignment layer 11 is rubbed toward the gate line, the linear afterimage is generated in a parallel direction with the gate line, and in this case, when the light blocking member overlapping with the gate line has a large thickness, the linear afterimage may be covered.

Accordingly, according to the exemplary embodiment of the present invention, the linear afterimage may be reduced by the corresponding light blocking member through the alignment layer 11 rubbed toward the light blocking member having a larger thickness.

Next, the upper panel 200 will be described.

A light blocking member 220 is formed on a second insulating substrate 210 made of transparent glass, plastic, or another appropriate material. The light blocking member 220 is called a black matrix and blocks light leakage.

The light blocking member 220 includes a light blocking member disposed in a horizontal direction and a light blocking member disposed in a vertical direction, as illustrated in FIG. 1. According to the exemplary embodiment of the present invention, the light blocking member disposed in the horizontal direction may be wider than the light blocking member disposed in the vertical direction, and it is not limited thereto.

Further, a plurality of color filters 230 is formed on the second insulating substrate 210.

An overcoat 250 is formed on the color filter 230 and the light blocking member 220. The overcoat 250 may be made of an organic insulator, which may include an organic material. The overcoat 250 prevents the color filter 230 from being exposed, and provides a flat surface. The overcoat 250 may be omitted.

An alignment layer 22 is disposed on the overcoat 250.

The liquid crystal layer 3 includes a positive-type liquid crystal or a negative-type liquid crystal, and as an example, includes the positive-type liquid crystal. Liquid crystal molecules of the liquid crystal layer 3 are aligned so that long-axial directions of the crystals are parallel to the panels 100 and 200, and the direction has a 90°-twisted structure in a spiral form from a rubbing direction of the alignment layer 11 of the lower panel 100 up to the upper panel 200.

The pixel electrode 191 receives a data voltage from the drain electrode 175, and the common electrode 270 receives a common voltage from a common voltage applying unit disposed outside the display area.

The pixel electrode 191 and the common electrode 270, which are field generating electrodes, generate an electric field so that liquid crystal molecules of the liquid crystal layer 3 disposed on the two electrodes 191 and 270 rotate in a direction parallel to the direction of the electric field. Polarization of light passing through the liquid crystal layer 3 varies according to the determined rotation directions of the liquid crystal molecules.

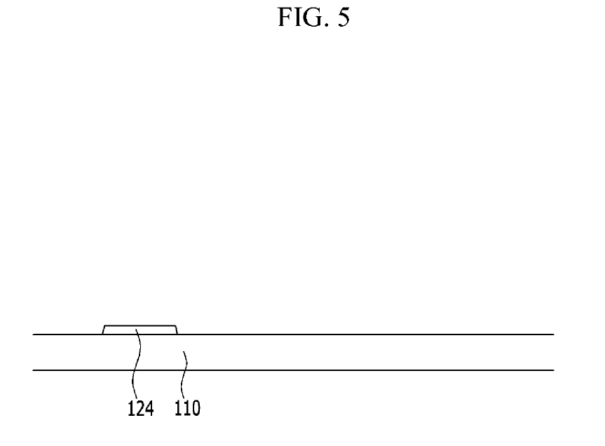

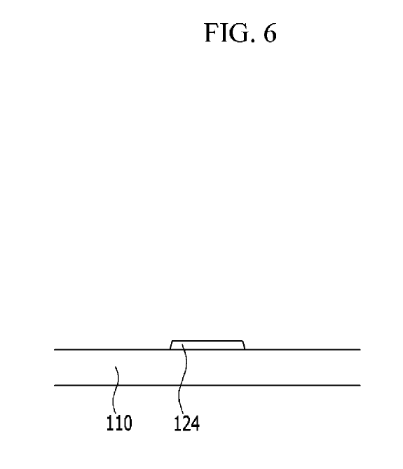

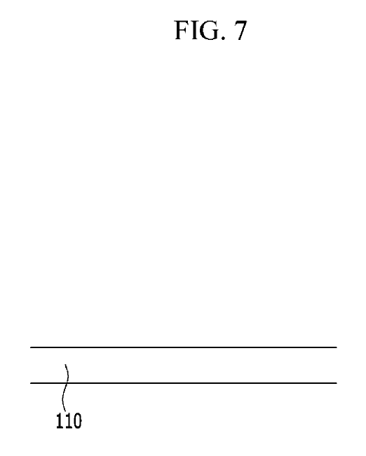

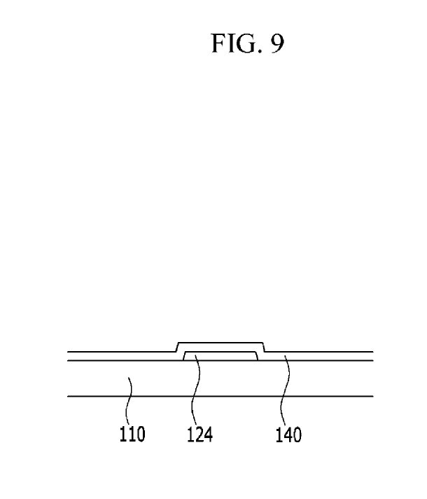

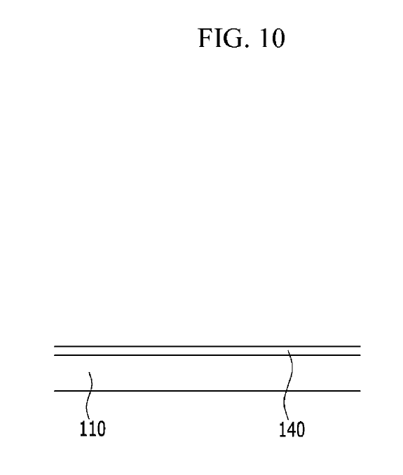

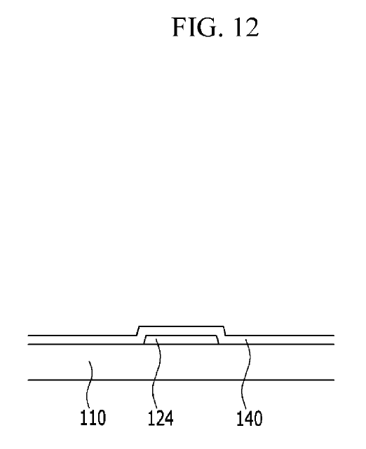

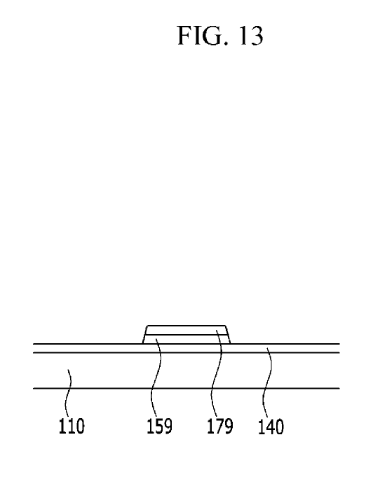

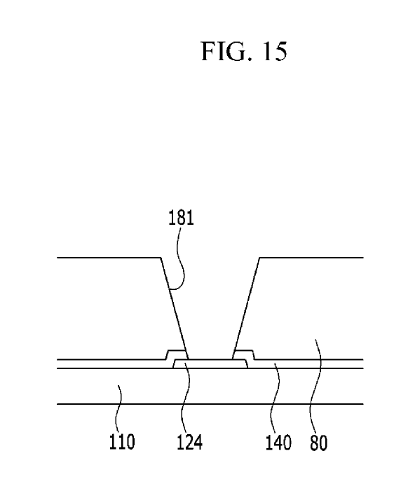

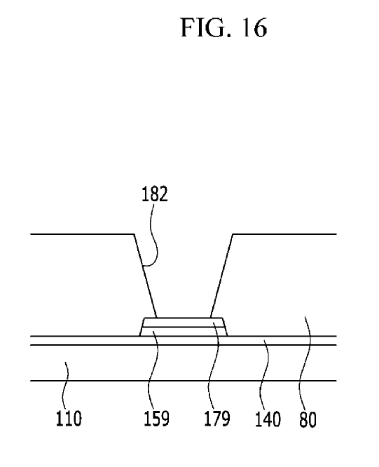

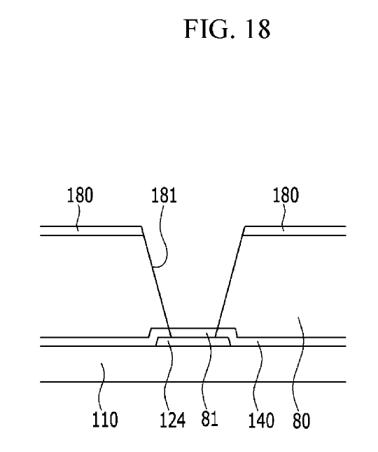

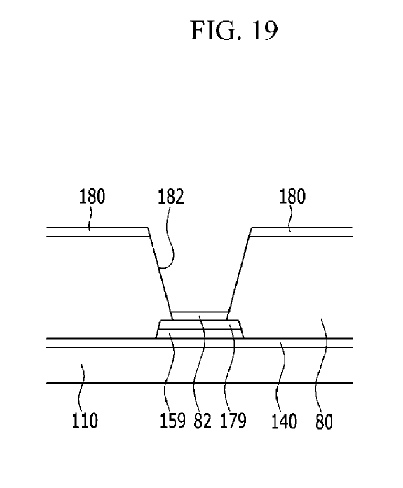

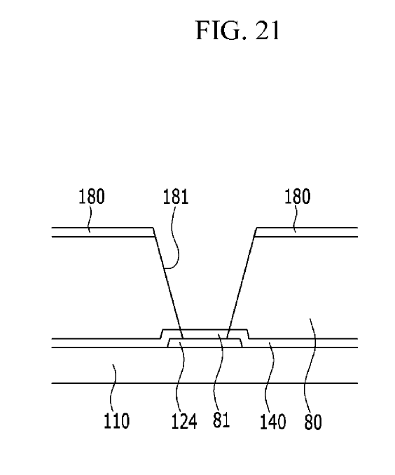

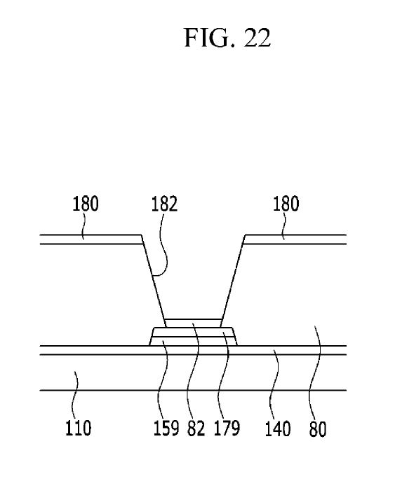

A manufacturing process of the lower panel 100 of the display device according to the exemplary embodiment of the present invention will be described with reference to FIGS. 5 to 22. FIGS. 5, 8, 11, 14, 17, and 20 are manufacturing processes of a cross section taken along line II-II, FIGS. 6, 9, 12, 15, 18, and 21 are manufacturing processes of a cross section taken along line III-III, and FIGS. 7, 10, 13, 16, 19, and 22 are manufacturing processes of a cross section taken along line IV-IV.

First, referring to FIGS. 5 to 7, the gate conductor, including the gate line 121, the gate electrode 124, and the gate pad 129 is formed on the insulating substrate 110.

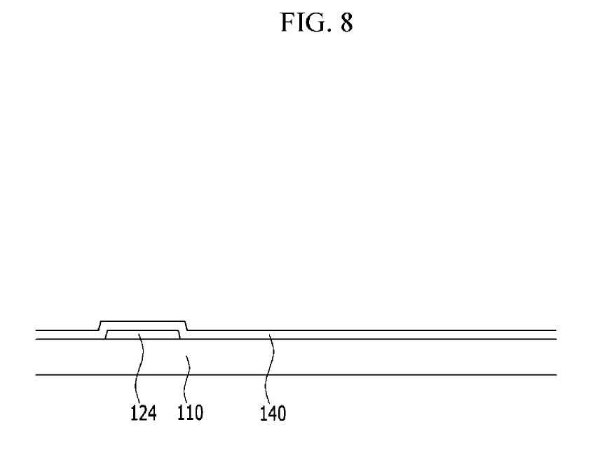

Next, as illustrated in FIGS. 8 to 10, the gate insulating layer 140 is laminated thereon. According to the exemplary embodiment of the present invention, it is illustrated and described that the gate insulating layer 140 is included, but the present invention is not limited thereto, and the gate insulating layer 140 may be omitted in circumstances in which DC bias effect due to the insulating layer 140 may be large.

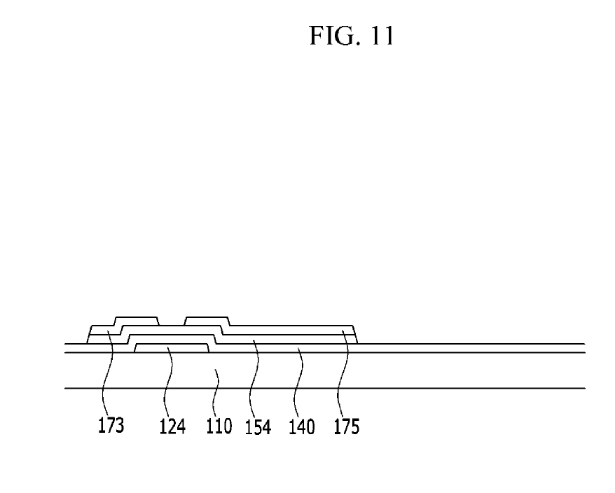

Next, as illustrated in FIGS. 11 to 13, the semiconductor 154, the first semiconductor 159, the ohmic contacts (not illustrated and may be omitted), and the data conductor, including the data line 171, the drain electrode 175, and the data pad 179 are formed on the gate insulating layer 140.

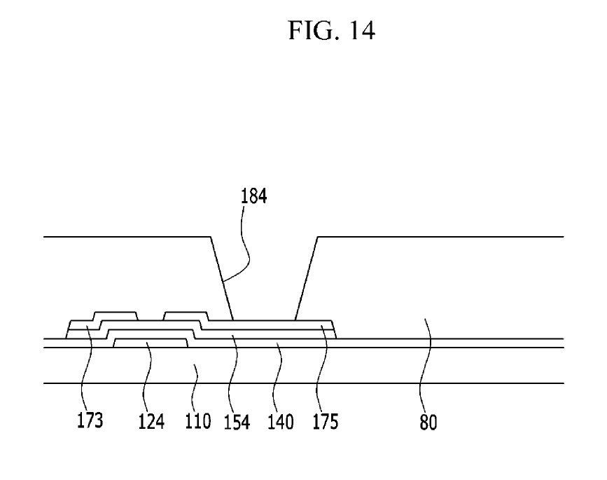

Next, as illustrated in FIGS. 14 to 16, the organic layer 80 including the contact hole is formed on the gate insulating layer 140, the data conductor 171, 175, and 179, and the exposed semiconductor 154.

A first contact hole 181 is formed to be disposed in a region corresponding to the gate pad 129 where the organic layer 80 is removed. A second contact hole 182 is formed to be disposed in a region corresponding to the data pad 179 where the organic layer 80 is removed. A third contact hole 184 is formed to be disposed in a region corresponding to the drain electrode 175 where the organic layer 80 is removed.

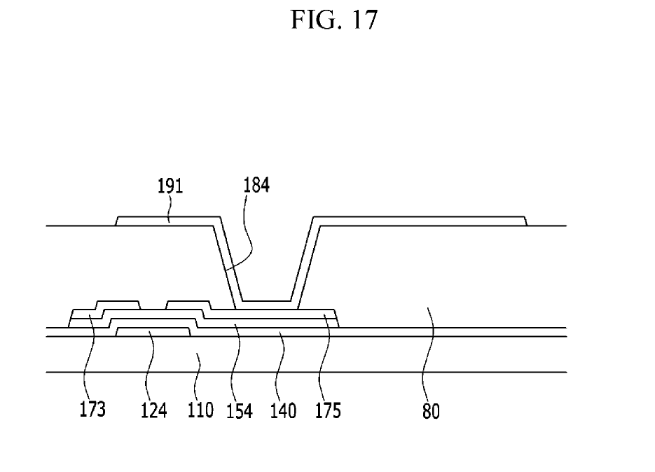

Next, referring to FIGS. 17 to 19, a conductive layer is laminated on the organic layer 80, and the pixel electrode 191 contacting the drain electrode 175 is formed using a photoresist pattern.

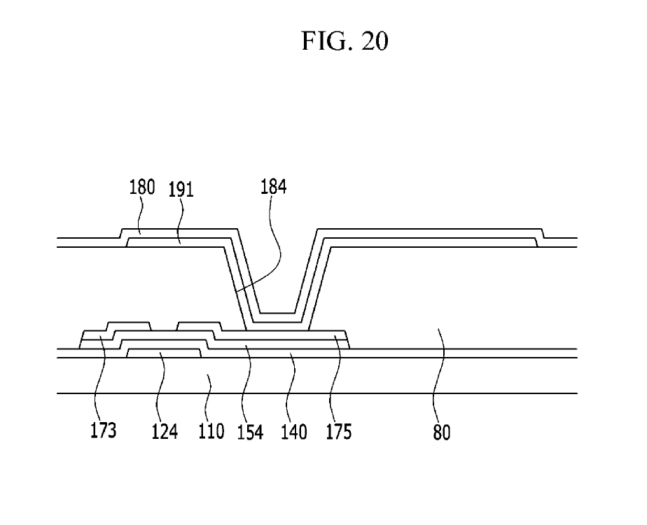

Next, referring to FIGS. 20 to 22, the passivation layer 180 is laminated to cover the pixel electrode 191 and the organic layer 80. In this case, the passivation layer 180 is removed from the gate pad 129 and the data pad 179 to contact the ohmic contacts 81 and 82.

The passivation layer 180 for preventing a short of the pixel electrode 191 and the common electrode 270 may be thinly formed in a thickness range such that the short is not generated. As an example of the present invention, a thickness of the passivation layer 180 may be from about 500 Å to about 3,000 Å. When the thickness of the passivation layer 180 is below about 500 Å, a short is generated between the pixel electrode 191 and the common electrode 270. However, when the thickness of the passivation layer 180 is above about 3000 Å, afterimages are often generated.

When charges are collected on the lower panel 100 by a DC bias, an effect due to one charge varies according to the formed thickness of the passivation layer 180.

When the thickness of the passivation layer is large, the effect due to one charge may be increased, and as a result, an afterimage may be rapidly generated and thus, an afterimage releasing may also be rapidly generated.

However, as described above, in the case of the passivation layer 180 having a small thickness, a DC bias reduction effect generated by one charge is reduced, and as a result, the afterimage generated by the DC bias may be generated slowly or reduced.

Next, the conductive layer is laminated on the structure of FIGS. 20 to 22, and the common electrode 270 is formed through the photoresist pattern. The common electrode 270 may, for example, include TCO including ITO, IZO, or another appropriate material.

Through the conductive layer, the first contact assistant 81 is disposed on the gate pad 129 exposed through the first contact hole 181 and the openings corresponding thereto, and the second contact assistant 82 is disposed on the data pad 179 exposed through the second contact hole 182 and the openings corresponding thereto.

Except for the alignment layer 11, the pixel electrode 191 or the common electrode 270 is disposed on the uppermost side of the lower panel 100.

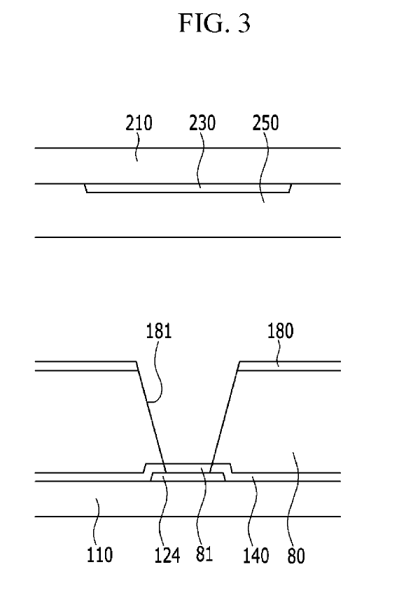

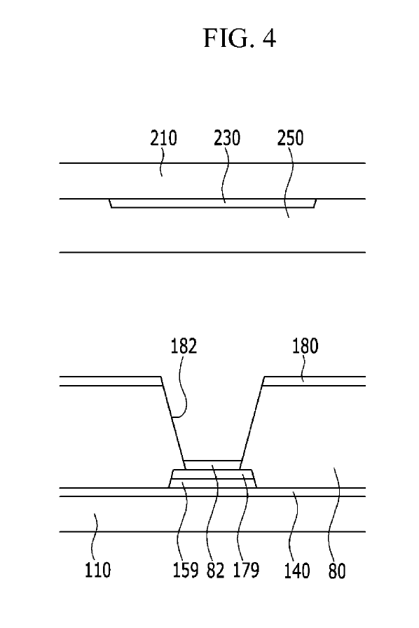

Next, like FIGS. 2 to 4, the alignment layer 11 is formed. The alignment layer may be made of any material that is not polarized and has high resistivity.

However, in the case of the alignment layer which is polarized, the polarization according to the change of the DC bias may be easily generated, and thus the afterimage may be easily generated. Accordingly, the liquid crystal display according to the exemplary embodiment of the present invention may include an alignment layer mainly including polyimides other than the mixed material or the polarized material. Resistivity of such an alignment layer may be from about 10⁻¹⁴ Ω·m to about 10⁻¹⁶ Ω·m. The ranges of the resistivity prevent from occurring afterimages.

The alignment layer 11 is rubbed in a direction. For example, the alignment layer 11 may be rubbed toward the thick light blocking member 220.

In detail, in the display device having the branch-shaped electrode structure parallel with the data line and including the positive-type liquid crystal, the rubbing direction is parallel with the branch-shaped electrode, and thus the alignment layer is rubbed toward the gate line 121. That is, the alignment layer is rubbed toward the light blocking member having a larger width.

Although not illustrated in this specification, in the display device which has the structure that the branch-shaped electrode is parallel with the gate line 121 and includes the negative-type liquid crystal, the rubbing direction is perpendicular to the branch-shaped electrode, and thus the alignment layer is rubbed toward the gate line 121. As described above, regardless of a kind of the liquid crystal, in the case where the alignment layer is rubbed toward the gate line 121, a linear afterimage is vertical thereto and may be covered by the light blocking member.

According to the exemplary embodiment of the present invention, the light blocking member disposed in a horizontal direction is larger than the light blocking member disposed in a vertical direction. In this case, the alignment layer may be rubbed toward the light blocking member disposed in the horizontal direction. Although not illustrated in this specification, when the light blocking member disposed in the vertical direction is wider than the light blocking member disposed in the horizontal direction, the alignment layer may be rubbed toward the light blocking member disposed in the vertical direction, that is, toward the data line 171.

This reduces the linear afterimage generated perpendicular to the rubbing direction. When the alignment layer is rubbed toward the gate line, the linear afterimage is generated in a direction parallel with the gate line, and this is because the linear afterimage may be covered by a width of the large thickness of the light blocking member overlapping with the gate line. Accordingly, according to the exemplary embodiment of the present invention, the alignment layer rubbed toward the light blocking member having a larger thickness is formed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display, comprising:
a first insulating substrate;
a gate line and a data line crossing each other, disposed on the first insulating substrate, and insulated from each other;
a thin film transistor electrically connected to the gate line and the data line;
an organic layer disposed on the thin film transistor;
a pixel electrode disposed on the organic layer;
a passivation layer disposed on the pixel electrode and comprising an opening; and
a common electrode disposed on the passivation layer,
wherein shapes of the passivation layer and the common electrode correspond to each other in a pixel area, and the pixel electrode is exposed through the opening.

2. The liquid crystal display of claim 1,
wherein the passivation layer comprises a plurality of openings, and the common electrode has a branch shape corresponding to the openings.

3. The liquid crystal display of claim 1, further comprising:
an alignment layer disposed on the common electrode,
wherein the alignment layer comprises polyimides.

4. The liquid crystal display of claim 3, wherein:
a resistivity of the alignment layer is from about 10⁻¹⁴ Ω·m to about 10⁻¹⁶ Ω·m.

5. The liquid crystal display of claim 1, wherein:
a thickness of the passivation layer is from about 500 Å to about 3,000 Å.

6. The liquid crystal display of claim 3, further comprising:
a second insulating substrate facing the first insulating substrate; and
a light blocking member disposed on the second insulating substrate,
wherein the light blocking member comprises
a horizontal light blocking member overlapping with the gate line, and
a vertical light blocking member overlapping with the data line.

7. The liquid crystal display of claim 6, wherein:
a width of the horizontal light blocking member is different from a width of the vertical light blocking member.

8. The liquid crystal display of claim 7, wherein:
a rubbing direction of the alignment layer is toward either the horizontal light blocking member or the vertical light blocking member.

9. The liquid crystal display of claim 8, wherein:
the rubbing direction of the alignment layer is toward one having a greater width of the horizontal light blocking member and the vertical light blocking member.

10. The liquid crystal display of claim 9, wherein:
the rubbing direction of the alignment layer is toward the horizontal light blocking member.

11. A manufacturing method of a liquid crystal display, comprising:
forming a gate line on a first insulating substrate;
forming a gate insulating layer on the gate line;
forming a data line on the gate insulating layer;
forming an organic layer on the data line, the organic layer comprising a contact hole;
forming a pixel electrode on the organic layer;
forming a passivation layer on the pixel electrode and comprising openings; and
forming a common electrode on the passivation layer,
wherein shapes of the passivation layer and the common electrode correspond to each other in a pixel area, and the pixel electrode is formed to be exposed through the openings.

12. The method of claim 11, wherein:
the common electrode has a branch shape corresponding to the openings.

13. The method of claim 11, further comprising:
forming an alignment layer on the common electrode,
wherein the alignment layer comprises polyimides.

14. The method of claim 13, wherein:
resistivity of the alignment layer is from about 10⁻¹⁴ Ω·m to about 10⁻¹⁶ Ω·m.

15. The method of claim 11, wherein:
a thickness of the passivation layer is from 500 Å to 3,000 Å.

16. The method of claim 13, further comprising:
forming a light blocking member disposed on a second insulating substrate facing the first insulating substrate,
wherein the light blocking member comprises
a horizontal light blocking member overlapping the gate line, and
a vertical light blocking member overlapping the data line.

17. The method of claim 16, wherein:
a width of the horizontal light blocking member is different from a width of the vertical light blocking member.

18. The method of claim 17, further comprising:
rubbing the alignment layer in a direction toward either the horizontal light blocking member or the vertical light blocking member.

19. The method of claim 18, wherein:
the alignment layer is rubbed in a direction toward having a greater width of the horizontal light blocking member and the vertical light blocking member.

20. The method of claim 19, wherein:
the alignment layer is rubbed toward the horizontal light blocking member.
